(19) United States
(12) Patent Application Publication
(10) Pub. No.: US 2021/0397003 A1
(43) Pub. Date: Dec. 23, 2021

(54) VIDEO PROJECTION SYSTEM, VIDEO PROJECTION DEVICE, VIDEO DISPLAY LIGHT DIFFRACTION OPTICAL ELEMENT, AND VIDEO PROJECTION METHOD

(71) Applicant: SONY CORPORATION, TOKYO (JP)

(72) Inventor: MASANORI IWASAKI, TOKYO (JP)

(21) Appl. No.: 17/288,732

(22) PCT Filed: Nov. 1, 2019
(86) PCT No.: PCT/JP2019/043147

§ 371 Date: Apr. 26, 2021

(30) Foreign Application Priority Data
Nov. 5, 2018 (JP) 2018-208099

(51) Int. Cl. G02B 27/01

(52) U.S. Cl. CPC G02B 27/0172; G02B 26/101; G02B 2027/0174; G02B 27/0179

(57) ABSTRACT

The present technology provides a video projection system (100) including: a video projection device (101) equipped with a projection optical system (110) configured to project video display light onto an eyeball (130); and an optical element (120) configured to cause the video display light to be collected near a pupil and then to reach a retina. The video projection system (100) is used in a state where a positional relationship between the optical element (120) and the eyeball (130) is fixed. Furthermore, the present technology also provides a video projection method including: a projection step of projecting video display light from a video projection device toward an eyeball; and a light collecting step of causing video display light projected in the projection step to be collected near a pupil with an optical element (120) and then to reach a retina. The projection step and the light collecting step are performed in a state where a positional relationship between the optical element (120) and the eyeball (130) is fixed.

### TECHNICAL FIELD

The present technology relates to a video projection system, a video projection device, a video display light diffraction optical element, and a video projection method. More specifically, the present technology relates to: a video projection system equipped with a projection optical system configured to project video display light onto an eyeball, and with an optical element configured to cause the video display light to be collected near a pupil and then to reach a retina; each element included in the video projection system; and a video projection method in the video projection system.

### BACKGROUND ART

In recent years, attention has been focused on technology of superimposing an image on a scene of an outside world. The present technology is also called augmented reality (AR) technology. One of products using this technology is a head-mounted display. The head-mounted display is used by being mounted on the head of a user. In an image display method using the head-mounted display, for example, when light from the head-mounted display reaches the user's eyes in addition to light from an outside world, the user recognizes an image of the light from the display as if being superimposed on an image of the outside world.

Regarding the AR technology, a video presentation method using a contact lens as an optical element has also been proposed. For example, Patent Document 1 below discloses a beam scanned type display device for displaying an image by scanning a user's retina with a beam. The beam scanned type display device includes: a chassis that mounts a light source for outputting a beam to draw each pixel configuring an image and a scan unit for performing a scan with the beam from the light source in two-dimensional direction; and a contact lens that includes a deflection unit for deflecting the beam with which the scan unit performs the scan in direction to the eye retina of the user wearing the chassis and is independent from the chassis.

### CITATION LIST

### Patent Document

Patent Document 1: International Publication No. 2009/066446

### SUMMARY OF THE INVENTION

### Problems to be Solved by the Invention

A head-mounted display that projects a video image directly onto a retina causes video display light to be collected near a pupil and to reach the retina. Therefore, when an eyeball is rotated by a user changing a visual line or the like, the video display light may not pass through the pupil and may not reach the retina. Therefore, a main object of the present technology is to provide a technique for recognizing a video image without being affected by a position of a pupil.

### Solutions to Problems

The present technology provides a video projection system including: a video projection device equipped with a projection optical system configured to project video display light onto an eyeball; and an optical element configured to cause the video display light to be collected near a pupil and then to reach a retina. The video projection system is used in a state where a positional relationship between the optical element and the eyeball is fixed.

According to one implementation aspect of the present technology, a main light beam of the video display light incident on the optical element may be substantially parallel to an optical axis.

According to one implementation aspect of the present technology, the optical element may be used in contact with a surface of the eyeball.

According to one implementation aspect of the present technology, the video projection system may be used in a state where a positional relationship between the optical element and the pupil is fixed.

According to one implementation aspect of the present technology, the optical element may be used without contacting a surface of the eyeball.

According to one implementation aspect of the present technology, the optical element may have a curved surface, and a curvature center of the curved surface and a curvature center of a curved surface of the surface of the eyeball may be substantially concentric.

According to one implementation aspect of the present technology, the optical element may be a holographic optical element.

According to one implementation aspect of the present technology, the projection optical system may include a two-dimensional array display element, and the two-dimensional array display element may form the video display light.

According to one implementation aspect of the present technology, the projection optical system may include a scanning mirror, and the scanning mirror may form the video display light.

According to one implementation aspect of the present technology, the projection optical system may include a partial multiplexing member, and the partial multiplexing member may reflect or diffract the video display light to reach the optical element.

According to one implementation aspect of the present technology, the optical element may have a holographic optical element layer, and the holographic optical element layer may diffract the video display light incident on the optical element to be collected near the pupil.

According to one implementation aspect of the present technology, the optical element may further have a 0th-order light reflecting layer, the optical element may have a lamination in an order of the holographic optical element layer and the 0th-order light reflecting layer from an outside world side, and the 0th-order light reflecting layer may reflect 0th-order light having passed through the holographic optical element layer to advance in a direction other than the eyeball.

According to one implementation aspect of the present technology, the holographic optical element layer may include a plurality of layers, and the plurality of layers may diffract light having a different wavelength from one another.

According to one implementation aspect of the present technology, the optical element may have a first holographic optical element layer and a second holographic optical element layer, the optical element may have a lamination in an order of the first holographic optical element layer and the second holographic optical element layer from an outside world side, the first holographic optical element layer may transmit the video display light, the second holographic optical element layer may reflect the transmitted video display light, and the first holographic optical element layer may diffract the reflected video display light to be collected near the pupil.

According to one implementation aspect of the present technology, the optical element may further have a 0th-order light reflecting layer, the optical element may have a lamination in an order of the first holographic optical element layer, the second holographic optical element layer, and the 0th-order light reflecting layer from an outside world side, and the 0th-order light reflecting layer may reflect the 0th-order light having passed through the first and second holographic optical element layers to advance in a direction other than the eyeball.

According to one implementation aspect of the present technology, the first and/or second holographic optical element layer may include a plurality of layers, and the plurality of layers may diffract light having a different wavelength from one another.

According to one implementation aspect of the present technology, the projection optical system may include a light discrimination element, and the light discrimination element may separate and remove an unnecessary wavelength component from the video display light.

According to one implementation aspect of the present technology, the optical element may have a holographic optical element layer, and the holographic optical element layer may diffract the video display light incident on the optical element to be collected on a front side or a back side of the pupil.

According to one implementation aspect of the present technology, there may be further provided: an eyeball position detection device configured to detect a position of the eyeball with respect to the optical element; and a control unit configured to specify a light beam group that reaches a retina on the basis of a detection result of the eyeball position detection device, and control the projection optical system to form the video display light with the light beam group.

Furthermore, the present technology also provides a video projection device including a projection optical system configured to project video display light onto an eyeball. The video projection device is used in combination with an optical element configured to cause the video display light to be collected near a pupil and then to reach a retina, and a positional relationship between the optical element and the eyeball is fixed in use in the combination.

Furthermore, the present technology also provides a video display light diffraction optical element that is used in combination with a video projection device equipped with a projection optical system configured to project video display light onto an eyeball, and a positional relationship with the eyeball is fixed in use in the combination. The video display light diffraction optical element causes the video display light to be collected near a pupil and then to reach a retina.

Furthermore, the present technology also provides a video projection method including: a projection step of projecting video display light from a video projection device toward an eyeball; and a light collecting step of causing video display light projected in the projection step to be collected near a pupil with an optical element and then to reach a retina. In the video projection method, the projection step and the light collecting step are performed in a state where a positional relationship between the optical element and the eyeball is fixed.

### BRIEF DESCRIPTION OF DRAWINGS

FIG. 1 is a view showing an example of a video projection system according to the present technology.

FIG. 2 is a view showing a relationship between a video display light diffraction optical element and video display light according to the present technology.

FIG. 3 is a view showing an example of the video projection system according to the present technology.

FIG. 4 is a view showing an example of the video projection system according to the present technology.

FIG. 5 is a view showing an example of the video projection system according to the present technology.

FIG. 6 is a view showing an example of the video projection system according to the present technology.

FIG. 7 is a view showing an example of the video projection system according to the present technology.

FIG. 8 is a view showing an example of a video projection device according to the present technology.

FIG. 9 is a view showing an example of the video projection device according to the present technology.

FIG. 10 is a view showing an example of the video projection device according to the present technology.

FIG. 11 is a view showing an example of the video projection device according to the present technology.

FIG. 12 is a view showing an example of the video projection device according to the present technology.

FIG. 13 is a view showing an example of the video projection device according to the present technology.

FIG. 14 is a view showing an example of the video projection device according to the present technology.

FIG. 15 is a view showing an example of the video projection device according to the present technology.

FIG. 16 is a view showing an example of the video display light diffraction optical element according to the present technology.

FIG. 17 is a view showing an example of the video display light diffraction optical element according to the present technology.

FIG. 18 is a view showing an experimental example of the video projection system according to the present technology.

FIG. 19 is a view showing an experimental example of the video projection system according to the present technology.

FIG. 20 is a view showing an experimental example of the video projection system according to the present technology.

FIG. 21 is a view showing an experimental example of the video projection system according to the present technology.

FIG. 22 is a view showing an experimental example of the video projection system according to the present technology.

FIG. 23 is a view showing an example of the video display light diffraction optical element according to the present technology.

FIG. 24 is a view showing an example of the video display light diffraction optical element according to the present technology.

FIG. 25 is a view showing an example of the video display light diffraction optical element according to the present technology.

FIG. 26 is a view showing an example of the video display light diffraction optical element according to the present technology.

FIG. 27 is a view showing an example of the video display light diffraction optical element according to the present technology.

FIG. 28 is a view showing an example of diffraction efficiency of the video projection system according to the present technology.

FIG. 29 is a view showing an example of diffraction efficiency of the video projection system according to the present technology.

FIG. 30 is a view showing an example of the video projection system according to the present technology.

FIG. 31 is a view showing an example of diffraction efficiency of the video projection system according to the present technology.

FIG. 32 is a view showing an example of diffraction efficiency of the video projection system according to the present technology.

FIG. 33 is a view showing a video projection system of Modified Example 1 according to the present technology.

FIG. 34 is a view showing the video projection system of Modified Example 1 according to the present technology.

FIG. 35 is a view showing the video projection system of Modified Example 1 according to the present technology.

FIG. 36 is a view showing a video projection system of Modified Example 2 according to the present technology.

FIG. 37 is a view showing the video projection system of Modified Example 2 according to the present technology.

FIG. 38 is a view showing the video projection system of Modified Example 2 according to the present technology.

FIG. 39 is a block diagram showing functions of the video projection systems of Modified Examples 1 and 2 according to the present technology.

### MODE FOR CARRYING OUT THE INVENTION

Hereinafter, a preferred mode for implementing the present technology will be described. Note that the embodiments described below show representative embodiments of the present technology, and do not limit the scope of the present technology. Note that the present technology will be described in the following order.

1. First embodiment (video projection system)

(1) Description of first embodiment

(2) First example of first embodiment (video projection system)

(3) Second example of first embodiment (video projection system)

(4) Third example of first embodiment (configuration example of video projection device)

(5) Fourth example of first embodiment (configuration example of optical element)

(6) Fifth example of first embodiment (configuration example of optical element)

(7) Sixth example of first embodiment (configuration example of video projection device)

2. Second embodiment (video projection device)

3. Third embodiment (video display light diffraction optical element)

4. Fourth embodiment (video projection method)

5. Modified example (video projection system)

### 1. First Embodiment (Video Projection System)

### (1) Description of First Embodiment

A video projection system according to the present technology includes: a video projection device equipped with a projection optical system; and an optical element. The projection optical system projects video display light toward the optical element provided in front of an eyeball. Since the optical element of the present technology is used in a state where a positional relationship with the eyeball is fixed, the video display light can be collected near a pupil even if a position of the eyeball with respect to the projection optical system moves, and a field of view that can be displayed is widened.

According to one implementation aspect of the present technology, the projection optical system may include a two-dimensional array display element. The two-dimensional array display element may form the video display light from illumination light emitted from a light source. The two-dimensional array display element may be, for example, an LCD, an LCOS, or an OLED.

According to another implementation aspect of the present technology, the projection optical system may include a scanning mirror. The scanning mirror may scan a laser beam emitted from the light source to cause the laser beam to reach the optical element. As a result of the scanning, a video image may be formed. The scanning mirror may be, for example, a MEMS mirror.

According to one implementation aspect of the present technology, the optical element may be used in contact with a surface of the eyeball. For example, the optical element may be used in a state where a positional relationship with a pupil is fixed. In the present implementation aspect, the optical element may be, for example, a contact-lens-shaped optical element having a material similar to that of a contact lens, and more particularly a contact lens-shaped holographic optical element. Since the optical element is the contact-lens-shaped optical element, it is possible to enlarge a field of view in which a video image by video display light can be recognized, for example, to 60 degrees or more. Furthermore, since the optical element is the contact-lens-shaped optical element, it is possible to easily enlarge an eye box (that is, a spatial area around the eyeball, in which a video image by video display light can be recognized).

According to another implementation aspect of the present technology, the optical element may be used without contacting a surface of the eyeball. In the present implementation aspect, the optical element may have, for example, a distance of 20 mm or less between a surface of the eyeball and an eyeball-side surface of the optical element. The distance may be 12 mm or more, for example, to prevent user's eyelashes from coming into contact with the optical element when mounted.

### (2) First Example of First Embodiment (Video Projection System)

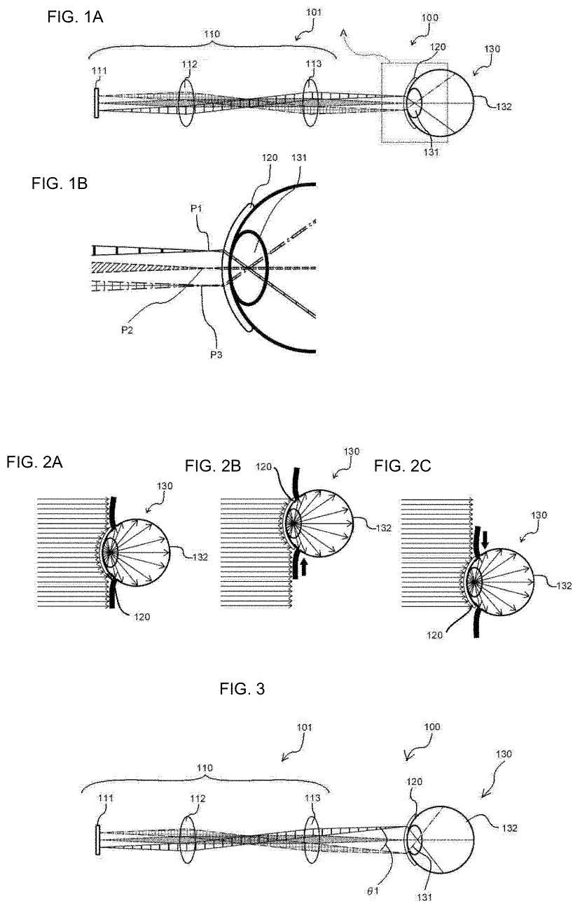

According to one implementation aspect of the present technology, the projection optical system includes a two-dimensional array display element. An example of a video projection system according to the present implementation aspect will be described with reference to FIGS. 1 to 4.

FIG. 1(a) is a schematic view showing an example of a video projection system 100 according to the present technology. Furthermore, FIG. 1(b) is an enlarged view of an area A of FIG. 1(a). Note that FIG. 1 schematically shows a main light beam and a peripheral light beam emitted from a projection optical system 110.

As shown in FIG. 1(a), the video projection system 100 includes a video projection device 101 and an optical element 120. Since the video projection system 100 is used in a state where a positional relationship between the optical element 120 and an eyeball 130 is fixed, a distance between the optical element 120 and a rotation center of the eyeball 130 does not change even if the eyeball 130 rotates. Therefore, it is not necessary to adjust video display light in accordance with movement of the eyeball, and it is not necessary to provide an eye tracking device.

The video projection device 101 includes the projection optical system 110, and the projection optical system 110 includes a two-dimensional array display element 111, a first lens 112, and a second lens 113.

The two-dimensional array display element 111 forms video display light from, for example, illumination light emitted from a light source (not shown). For example, on an optical path between the light source and the two-dimensional array display element 111, an imaging system and a color separation synthesis system may be provided. An arrangement of these components may be appropriately designed by those skilled in the art. The two-dimensional array display element 111 may be, for example, an LCD, an LCOS, or an OLED.

Emission of the video display light by the two-dimensional array display element 111 may be controlled by, for example, a control unit (not shown). That is, the video projection device 101 may include a control unit (not shown) configured to control emission of the video display light by the two-dimensional array display element 111. The control unit may include, for example, a central processing unit (CPU) and a RAM. As the CPU, any processor may be used. The RAM may include, for example, a cache memory and a main memory, and temporarily store a program used by the CPU. The video projection device 101 may further include, for example, various components used for controlling a video display element, such as a disk, a communication device, and a drive. The disk may store, for example, various image data and various programs such as a program for realizing emission of video display light by the two-dimensional array display element 111. The communication device may acquire image data and/or a program for controlling the video display element, from a network, for example. The drive may read out a program and/or image data recorded on, for example, a recording medium such as a microSD memory card and an SD memory card, and output to the RAM.

In a video presentation method (also called image presentation by Maxwellian view) in which video display light is collected near a pupil and reaches the retina, conventionally, a scanning mirror has often been used. In a case of using a scanning mirror, it is required to use a laser beam as a light source.

In the video projection system of the present technology, since the two-dimensional array display element can be used as described above, a range of selection of the light source is widened. Furthermore, in a case of scanning the laser beam with a scanning mirror, it is difficult to widen a display field angle, and a display time per pixel may become shorter and display driving may be difficult when the number of pixels is to be increased. However, the two-dimensional array display element makes it possible to easily increase the number of pixels by increasing the number of pixels of the display element even in a case of a wide viewing angle.

The first lens 112 and the second lens 113 are provided between the two-dimensional array display element 111 and the optical element 120. As shown in FIG. 1(a), the video display light projected from the two-dimensional array display element 111 is refracted by the first lens 112 and further refracted by the second lens 113 to be incident on the optical element 120.

As shown in FIG. 1(b), the video projection system 100 is configured such that video display light refracted by the second lens 113 has a focal point at P1 to P3 immediately before the optical element 120. Since the video display light has the focal point immediately before the optical element 120, peripheral light beams are prevented from being dismissed by the pupil, and peripheral light beams can be sufficiently incident on the pupil. Therefore, when the optical element 120 causes peripheral light beams to be collected near the pupil, a bright image can be projected onto a retina 132. A distance between the focal point and the optical element 120 may be set in accordance with an amount of peripheral light beams desired to be incident on the pupil.

In the present embodiment, a main light beam of video display light incident on the optical element 120 may preferably have a direction such that the video display light may be collected near the pupil after being incident on the optical element 120, and more preferably, may be substantially parallel to an optical axis. That is, in the present embodiment, it is preferable that the main light beam of the video display light reaches the optical element 120 as a telecentric light beam. The projection optical system 110 may be configured such that video display light whose main light beam is substantially parallel to the optical axis is incident on the optical element 120.

As shown in FIG. 2, since the main light beam of the video display light is substantially parallel to the optical axis, the video display light can be collected near the pupil even if a position of the optical element 120 and the eyeball 130 changes. Specifically, for example, even if the optical element 120 and the eyeball 130 move to a position shown in FIG. 2(b) or 2(c) from a position shown in FIG. 2(a), the video display light can be collected near the pupil and guided to the retina 132.

Furthermore, when the main light beam of the video display light is substantially parallel to the optical axis, an angle and a position of the main light beam of the video display light incident on the optical element 120 are always unchanged, even if a position of the optical element 120 and the eyeball 130 changes. Therefore, according to the present embodiment, it is possible to prevent a change of resolution of a central portion of a field of view recognized by the user, even if the eyeball 130 is moved.

In the present embodiment, the projection optical system 110 may be configured such that the video display light is collected near the pupil and reaches the retina 132. That is, the video display light may be projected onto the retina 132 by so-called Maxwellian view. For example, as shown in FIG. 1(a), the video display light projected from the projection optical system 110 is diffracted by the optical element 120. The diffracted video display light is collected near the pupil and then reaches the retina 132.

In the Maxwellian view optical system, since one dot (a minimum display unit) in a displayed video image passes through one point on a crystalline lens 131, the one-dot image on the retina is less susceptible to a state of the crystalline lens 131. Therefore, even a user having, for example, myopia, hyperopia, astigmatism, or the like can clearly recognize the video image. Furthermore, a virtual image that appears to float in a space is focus-free, and the virtual image comes into focus at any distance from the eye.

In the present technology, the video display light may be collected near the pupil, and, for example, may be collected on the pupil or may be shifted from the pupil by several mm to a dozen mm (for example, 1 mm to 20 mm, particularly 2 mm to 15 mm) in an optical axis direction. As in the latter case, Maxwellian view can be realized even if the focal point is not on the pupil. Shifting the focal point in the optical axis direction can make it difficult for the user to lose a video image even if the video image is shifted. More specifically, the video display light may be collected on the pupil, in the crystalline lens 131, or between a cornea surface and the pupil.

In the present embodiment, a main light beam of video display light may diverge or converge on condition that the video display light is collected near the pupil. The main light beam diverging or converging in this way is included in the main light beam that is “substantially parallel” in the present technology. For example, a main light beam that is slightly diverging or converging due to a manufacturing tolerance is included in the main light beam that is “substantially parallel”.

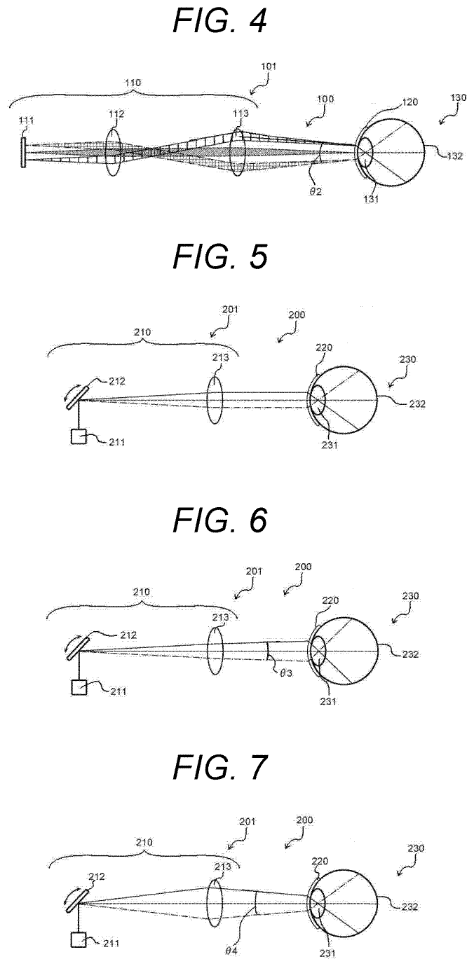

For example, the video display light refracted by the second lens 113 may diverge as shown in FIG. 3 or may converge as shown in FIG. 4. When the main light beam diverges, a difference θ₁ between a maximum angle and a minimum angle with respect to an optical axis is preferably 5 degrees or less, 4 degrees or less, 3 degrees or less, 2 degrees or less, or 1 degree or less. There are no particular restrictions in a case where the main light beam converges, but a difference θ2 between a maximum angle and a minimum angle with respect to an optical axis is more preferably 5 degrees or less, 4 degrees or less, 3 degrees or less, 2 degrees or less, or 1 degree or less.

The optical element 120 causes the video display light to be collected near the pupil and to reach the retina 132.

In the present technology, the optical element 120 is used in a state where a positional relationship with the eyeball 130 is fixed. Preferably, as shown in FIG. 1, the optical element 120 may be provided in contact with the eyeball 130, for example, and may be used in a state where the positional relationship between the optical element 120 and the pupil is fixed. Furthermore, the optical element 120 may have a curved surface, and a curvature center of the curved surface and a rotation center of the eyeball 130 may be concentric. By fixing the positional relationship between the optical element 120 and the pupil, the video display light refracted by the lens 113 can be collected near the pupil even if the eyeball 130 rotates to change a position of the pupil.

In the present technology, the optical element 120 is, for example, a contact-lens-shaped optical element, and may preferably be a contact-lens-shaped holographic optical element. Since the optical element 120 is the contact-lens-shaped optical element, it is possible to enlarge a field of view in which a video image by video display light can be recognized, for example, to 60 degrees or more, and more particularly 100 degrees or more. Furthermore, since the optical element 120 is the contact-lens-shaped optical element, it is possible to easily enlarge an eye box (that is, a spatial area around the eyeball, in which a video image by video display light can be recognized).

Such a holographic optical element layer may be manufactured by a technique known in the technical field, or may be given with a desired optical characteristic by a technique known in the technical field. For example, it is possible to use, as it is as the optical element 120, a holographic optical element manufactured so as to collect video display light projected from the projection optical system 110 near the pupil, or it is possible to form one or two or more of the holographic optical element layers inside a protective layer having a material generally used as a contact lens material, and use as the optical element 120.

Alternatively, it is also possible to form a photopolymer layer on a surface of a commercially available contact lens or inside a protective layer having a material generally used as contact lens material, and form a hologram, in the photopolymer layer, so that video display light projected from the projection optical system 110 is collected near the pupil, to use as the optical element 120. Furthermore, a diffraction optical element of a relief-type generally called DOE may be used as the optical element 120. Alternatively, it is also possible to use, as the optical element 120, an emboss-type hologram obtained by creating, with use of an imprint method or the like, an uneven surface on a surface of a commercially available contact lens or inside a protective layer having a material generally used as contact lens material, and forming an interference fringe so that video display light projected from the projection optical system 110 is collected near the pupil. The optical element 120 may have a function as a contact lens (for example, a visual acuity correction function), or may not have such a function.

### (3) Second Example of First Embodiment (Video Projection System)

According to another implementation aspect of the present technology, the projection optical system includes a scanning mirror. An example of the video projection system in the present implementation aspect will be described with reference to FIGS. 5 to 7. Note that, since the description (2) described above applies to an optical element, the description will be omitted in the following.

FIG. 5 is a schematic view showing an example of a video projection system 200 according to the present technology.

As shown in FIG. 5, the video projection system 200 includes a video projection device 201 and an optical element 220. The video projection device 201 includes a projection optical system 210, and the projection optical system 210 includes a light source 211, a scanning mirror 212, and a lens 213.

The light source 211 emits a light beam toward the scanning mirror 212. As the light source 211, for example, an LED or an LD may be used. The light source 211 may be outputted as a single luminous flux including, for example, red, green, and blue laser beams.

The scanning mirror 212 may two-dimensionally scan a laser beam emitted from the light source 211 to cause the laser beam to reach the optical element 220. As the scanning mirror 212, for example, a MEMS mirror may be used. The scanning mirror 212 may move a direction of the laser beam at a high speed so that a video image is formed on a retina 232.

Emission of video display light from the light source 211 may be controlled by, for example, a control unit (not shown). That is, the video projection device 201 may include a control unit (not shown) configured to control emission of the video display light by the light source 211. Furthermore, the control unit may control driving of the scanning mirror 212. For example, the control unit may change a scanning swing angle of the scanning mirror 212. The control unit may include, for example, a central processing unit (CPU) and a RAM. As the CPU, any processor may be used. The RAM may include, for example, a cache memory and a main memory, and temporarily store a program used by the CPU. The video projection device 201 may further include, for example, various components used for controlling a video display element, such as a disk, a communication device, and a drive. The disk may store, for example, various image data and various programs such as a program for realizing emission of video display light by the light source 211. The communication device may acquire image data and/or a program for controlling the video display element, from a network, for example. The drive may read out a program and/or image data recorded on, for example, a recording medium such as a microSD memory card and an SD memory card, and output to the RAM.

The lens 213 is provided between the light source 211 and the optical element 220. As shown in FIG. 5, the video display light projected from the light source 211 is refracted by the lens 213 and incident on the optical element 220.

In the present embodiment, a main light beam of video display light incident on the optical element 220 may preferably have a direction such that the video display light may be collected near the pupil after being incident on the optical element 220, and more preferably, may be substantially parallel to an optical axis. That is, in the present embodiment, it is preferable that the main light beam of the video display light reaches the optical element 220 as a telecentric light beam. The projection optical system 210 may be configured such that video display light whose main light beam is substantially parallel to the optical axis is incident on the optical element 220.

As described with reference to FIG. 2 in (2) described above, since the main light beam of the video display light is substantially parallel to the optical axis, the video display light can be collected near the pupil even if a position of the optical element 220 and an eyeball 230 changes. Furthermore, in the present embodiment, since the video display light is projected onto the retina 232 by so-called Maxwellian view, the effect of Maxwellian view described in (2) described above is similarly produced.

Also in the present embodiment, similarly to (2) described above, the main light beam of the video display light may diverge or converge on condition that the video display light is collected near the pupil.

For example, the video display light refracted by the lens 213 may diverge as shown in FIG. 6 or may converge as shown in FIG. 7. In a case where the main light beam diverges, a difference θ₃ between a maximum angle and a minimum angle with respect to an optical axis is preferably 5 degrees or less, 4 degrees or less, 3 degrees or less, 2 degrees or less, or 1 degree or less. There are no particular restrictions in a case where the main light beam converges, but a difference θ₄ between a maximum angle and a minimum angle with respect to an optical axis is more preferably 5 degrees or less, 4 degrees or less, 3 degrees or less, 2 degrees or less, or 1 degree or less.

### (4) Third Example of First Embodiment (Configuration Example of Video Projection Device)

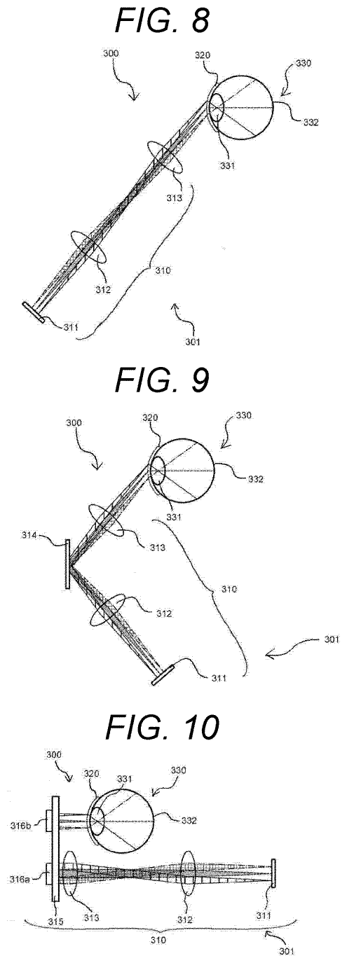

A configuration example of the video projection device is shown with reference to FIGS. 8 to 15. In the configuration example shown below, since there is no projection optical system in a front line-of-sight of a user, it is possible to guide video display light to a retina without blocking a front field of view, and the video projection system can be made a so-called see-through type.

As shown in FIG. 8, a video projection device 301 may be configured to project a main light beam of video display light obliquely with respect to an eyeball 330. Note that, an angle at which the video display light is projected may be appropriately set by those skilled in the art, within a range that does not block a line-of-sight direction of a user, on condition that the video display light is collected near the pupil. For example, the video projection device 301 may be provided on a side of a face or above eyes (for example, near a forehead). According to this configuration, since there is no optical component in front of the eyeball 330, it is possible to realize a field of view close to that of a naked eye.

As shown in FIG. 9, the video projection device 301 may include a reflection mirror 314. The video projection device 301 may be configured to cause video display light emitted from a projection optical system 310 to be reflected by the reflection mirror 314, and projected obliquely to the eyeball 330. According to this configuration, since there is no optical component in front of the eyeball 330, it is possible to realize a field of view close to that of a naked eye, and to make the video projection device 301 more compact than that in FIG. 8.

As shown in FIG. 10, the video projection device 301 may include a light guide plate 315, a first hologram 316a, and a second hologram 316b. The video projection device 301 may be configured to project a main light beam of video display light from a front direction of the pupil, by causing video display light emitted from the projection optical system 310 to be diffracted by the first hologram 316a, totally reflected in the light guide plate 315, and diffracted by the second hologram 316b. The light guide plate 315 may be formed by a light guide plate material known in the technical field, and may be formed, for example, from an acrylic resin (for example, PMMA or the like), a cycloolefin resin (for example, COP or the like), or a polycarbonate resin. Furthermore, the first hologram 316a and the second hologram 316b may be, for example, a holographic optical element.

Note that, in FIG. 10, the first hologram 316a and the second hologram 316b are provided on a back side of the light guide plate 315 when viewed from the eyeball 330, but the first hologram 316a and the second hologram 316b may be provided on a front side of the light guide plate 315.

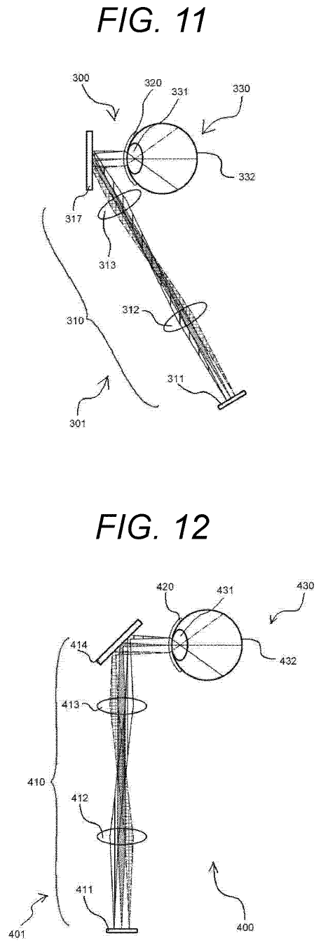

As shown in FIG. 11, the video projection device 301 may include a reflective holographic optical element 317 in front of the eyeball 330. The video projection device 301 may be configured to cause video display light emitted from the projection optical system 310 to be reflected by the reflective holographic optical element 317, and projected onto the eyeball 330. The reflective holographic optical element 317 may be a reflective holographic optical element known in the technical field.

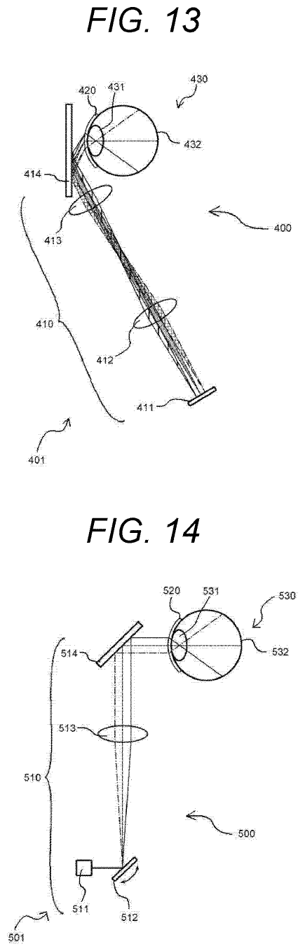

As shown in FIGS. 12 and 13, a video projection device 401 may include a partial multiplexing member 414. For the partial multiplexing member 414, for example, a half mirror may be used. The partial multiplexing member 414 may have a characteristic of reflecting or diffracting video display light emitted from a projection optical system 410 to reach an optical element 420, and transmitting light from an outside world. According to the partial multiplexing member 414, since it is possible to cause the video display light to reach a retina 432 without blocking a view of an outside world, the view of the outside world and the video display light may be superimposed.

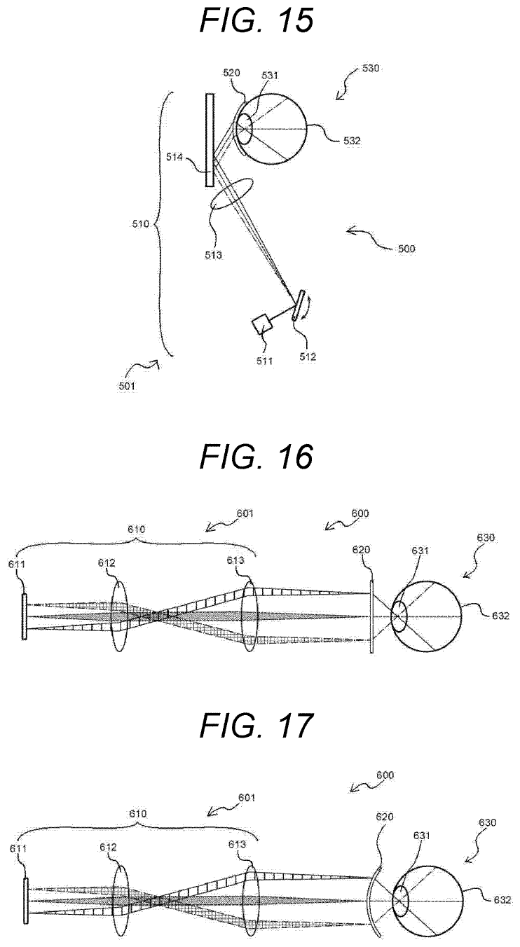

Note that the partial multiplexing member 414 is not limited to the case where a two-dimensional array display element 411 forms video display light, but can be similarly used in a case where video display light is formed by a light source 511 and a scanning mirror 512, as shown in FIGS. 14 and 15.

### (5) Fourth Example of First Embodiment (Configuration Example of Optical Element)

According to one implementation aspect of the present technology, the optical element may be used without contacting a surface of an eyeball. An example of a video projection system in the present implementation aspect will be described with reference to FIGS. 16 and 17.

An optical element 620 may be used, for example, in a state where a distance between a surface of an eyeball 630 and an eyeball-side surface of the optical element 620 is, for example, 20 mm or less, preferably 18 mm or less. The distance may be, for example, 12 mm or more, preferably 14 mm or more so that user's eyelashes do not come into contact with the optical element when mounted.

Furthermore, as shown in FIG. 17, the optical element 620 may have a curved surface. It is preferable that a curvature center of the curved surface and a curvature center of a surface of the eyeball 630 are substantially concentric. Moreover, it is more preferable that a curvature center of the curved surface and a rotation center of the eyeball 630 are substantially concentric. According to this configuration, since the optical element 620 can guide video display light to the pupil even if the eyeball 630 rotates, a field of view can be widened. Note that, in the present embodiment, the curvature center of the curved surface of the optical element 620 and the curvature center of the surface of the eyeball 630 may have some deviation, on condition that the video display light is collected near the pupil. Such some deviation is also included in “substantially concentric” in the present technology. For example, “substantially concentric” even includes a slight deviation between the curvature center of the curved surface of the optical element 620 and the curvature center of the surface of the eyeball 630 due to a manufacturing tolerance of the optical element 620.

A viewing angle achieved by an example of a video projection system according to the present embodiment was tested as follows.

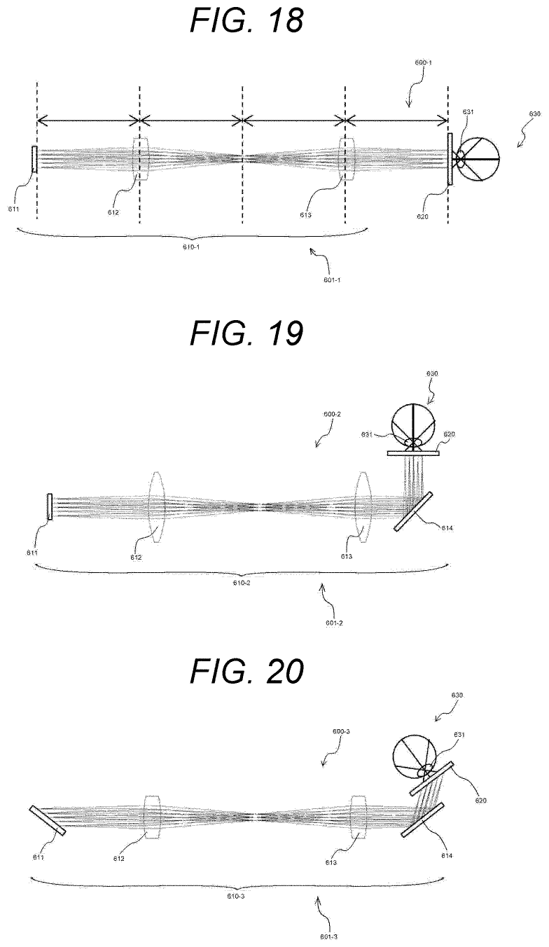

As shown in FIG. 18, a two-dimensional array display element 611, a first lens 612 (a focal length 75 mm), a second lens 613 (a focal length 75 mm), and an optical element 620, which are included in a video projection system 600-1, were provided in front of the eyeball 630 so as to be a 4f optical system. The video projection system 600-1 was configured so that video display light from the light source 611 was to reach the optical element 620 in substantially parallel to an optical axis. The optical element 620 was configured by a reflective holographic optical element having a two-layer structure. The reflective holographic optical element having the two-layer structure was adapted such that a holographic optical element on the eyeball side reflected video display light incident from a front direction of the eyeball 630 (that is, 0 degrees with respect to an optical axis) in a perpendicular direction (that is, 0 degrees with respect to an incident direction), and a holographic optical element on an outside world side reflected the reflected video display light with an NA of 0.78 in a perpendicular direction (that is, 0 degrees with respect to an incident direction). With such the video projection system 600-1, a viewing angle of 102.5 degrees can be obtained. As described above, a wide viewing angle can be obtained by the video projection system according to the present embodiment.

FIG. 19 shows another example of a video projection system 600-2. After the second lens 613 in the example described above, a half mirror 614 is provided at an angle of 45 degrees with respect to the first lens 612 and the second lens 613, and the optical element 620 is provided at an angle of 90 degrees with respect to the two-dimensional array display element 611. In this example, when the optical element 620 having a configuration similar to that of the example described above was used, it was possible to obtain a viewing angle of 102.5 degrees without blocking a field of view in a front direction. As described above, a wide viewing angle can be obtained by the video projection system according to the present embodiment.

FIG. 20 shows yet another example of a video projection system 600-3. The two-dimensional array display element 611 in the example described above was provided at an angle of 55 degrees with respect to the first lens 612 and the second lens 613, the half mirror 614 was provided after the second lens 613 at an angle of 53 degrees with respect to the first lens 612 and the second lens 613, and the optical element 620 was provided to be parallel to the half mirror 614 (that is, at an angle of 53 degrees with respect to the first lens 612 and the second lens 613). In this example, when the optical element 620 having a configuration similar to that of the example described above was used, it was possible to obtain a viewing angle of 102.5 degrees without blocking a field of view in a front direction. As described above, a wide viewing angle can be obtained by the video projection system according to the present embodiment.

As another example, as shown in FIG. 21, a light source 615, a MEMS mirror 616, a lens 617, and an optical element 620, which are included in a video projection system 600-4, were provided in front of the eyeball 630. The video projection system 600-4 was configured so that video display light from the light source 615 was to reach the optical element 620 in substantially parallel to an optical axis. In this example, when the optical element 620 having a configuration similar to that of the example described above was used, it was possible to obtain a viewing angle of 102.5 degrees. As described above, a wide viewing angle can be obtained by the video projection system according to the present embodiment.

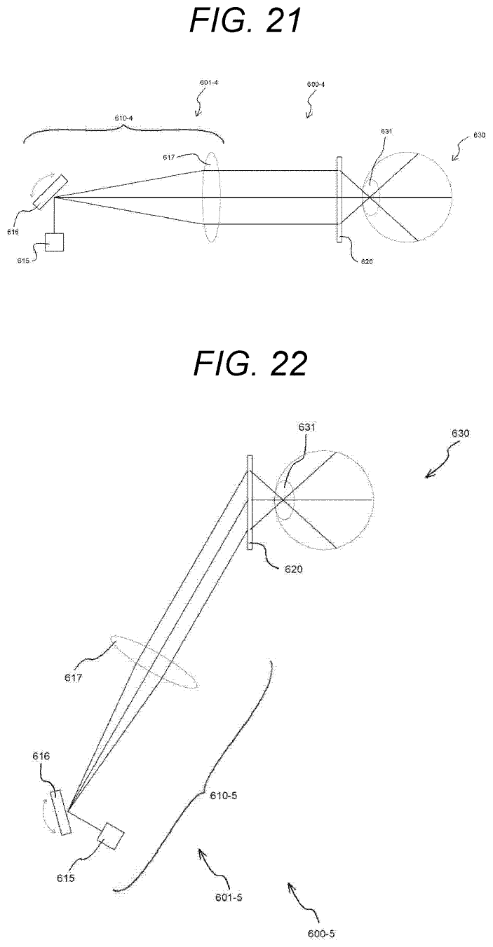

As yet another example, as shown in FIG. 22, a light source 615, a MEMS mirror 616, and a lens 617, which are included in a video projection system 600-5, were provided obliquely at 60 degrees from a front direction of the eyeball 630, and an optical element 620 was provided in front of the eyeball 630. The video projection system 600-5 was configured so that video display light from the light source 615 was to reach the optical element 620 in substantially parallel to an optical axis. The optical element 620 was configured by a reflective holographic optical element having a two-layer structure. The reflective holographic optical element having the two-layer structure was adapted such that a holographic optical element on the eyeball side reflected video display light incident obliquely at 60 degrees with respect to a front direction of the eyeball 630, in a perpendicular direction (that is, 0 degrees with respect to an incident direction), and a holographic optical element on an outside world side reflected the reflected video display light with an NA of 0.78 in a perpendicular direction (that is, 0 degrees with respect to an incident direction). With such the video projection system 600-5, it was possible to obtain a viewing angle of 102.5 degrees without blocking a field of view in the front direction.

Conventionally, it has been difficult to obtain a viewing angle exceeding 100 degrees with the see-through type, but the present embodiment makes it possible to obtain a viewing angle exceeding 100 degrees.

### (6) Fifth Example of First Embodiment (Configuration Example of Optical Element)

According to one implementation aspect of the present technology, the optical element may have one or more optical element layers. An example of the optical element in the present implementation aspect will be described with reference to FIGS. 23 to 27. Note that, in FIGS. 23 to 27, light beams shown by solid lines are incident light beams and emitted light beams, and light beams shown by dotted lines are 0th-order light.

As shown in FIG. 23, an optical element 720 may have a holographic optical element layer 721. This holographic optical element layer 721 may diffract video display light incident on the optical element 720 to be collected near the pupil. In the present embodiment, the optical element 720 may have protective layers 722a and 722b on an outside world side and the eyeball side, respectively.

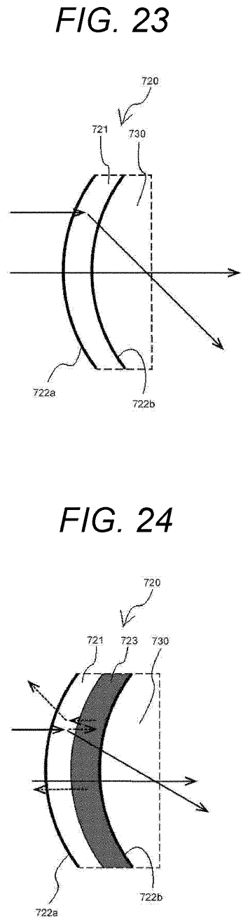

As shown in FIG. 24, the optical element 720 may further include a 0th-order light reflecting layer 723. In the present embodiment, the optical element 720 may have a lamination in an order of the holographic optical element layer 721 and the 0th-order light reflecting layer 723 from an outside world side. The 0th-order light reflecting layer 723 may reflect 0th-order light having passed through the holographic optical element layer 721 to advance in a direction other than the eyeball. According to this configuration, since the video display light can be made to reach the eyeball 730 without being affected by the 0th-order light, a video image can be clearly recognized.

Note that the holographic optical element layer 721 may be formed with, for example, multiple three holograms diffracting red, green, and blue light in one layer, or may include a plurality of layers. The plurality of layers may be configured to diffract light having a different wavelength from one another. By the holographic optical element layer 721 including the plurality of layers, diffraction efficiency of video display light can be improved.

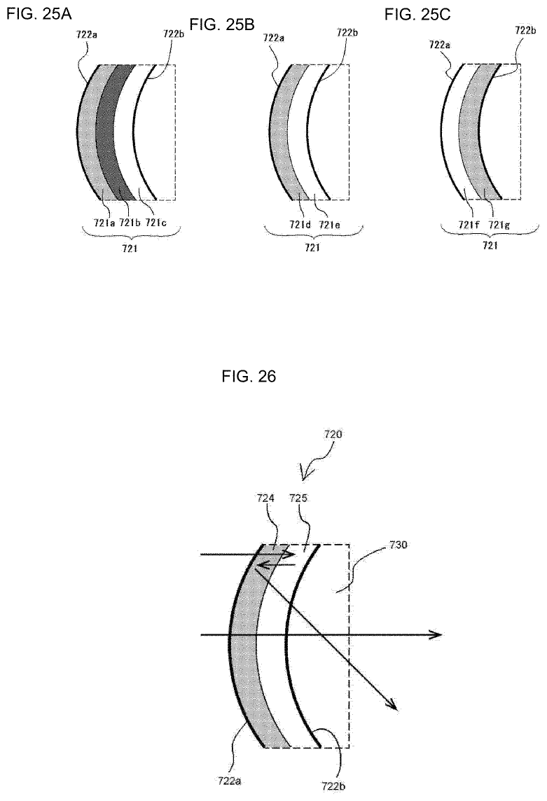

FIGS. 25(a) to 25(c) show an example in which the holographic optical element layer 721 includes a plurality of layers. For example, as shown in FIG. 25(a), one layer may be provided for every wavelength desired to be diffracted in the holographic optical element layer 721. Specifically, from an outside world side, a layer 721a that diffracts a red wavelength, a layer 721b that diffracts a green wavelength, and a layer 721c that diffracts a blue wavelength may be laminated in this order. Alternatively, as shown in FIGS. 25(b) and 25(c), multiple holograms that diffract light of a plurality of wavelengths may be formed in one layer included in the holographic optical element layer 721. Specifically, as shown in FIG. 25(b), a layer 721d that diffracts red and blue wavelengths and a layer 721e that diffracts a green wavelength may be laminated in this order from the outside world side. Alternatively, as shown in FIG. 25(c), a layer 721f that diffracts a green wavelength and a layer 721g that diffracts red and blue wavelengths may be laminated in this order from an outside world side.

As shown in FIG. 26, the optical element 720 may have a first holographic optical element layer 724 and a second holographic optical element layer 725. In the present embodiment, in the optical element 720, the first holographic optical element layer 724 and the second holographic optical element layer 725 may be laminated in this order from an outside world side. The first holographic optical element layer 724 may transmit video display light incident on the optical element 720, the second holographic optical element layer 725 may reflect the transmitted video display light, and the first holographic optical element layer 724 may diffract the reflected video display light to be collected near the pupil. Also in the present embodiment, the optical element 720 may have protective layers 722a and 722b on the outside world side and the eyeball side, respectively.

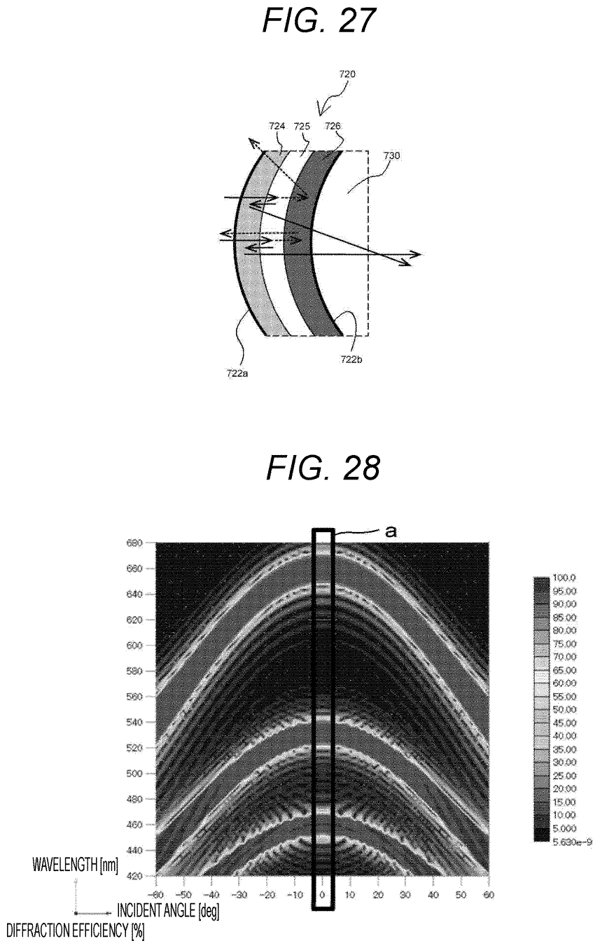

As shown in FIG. 27, the optical element 720 may further include a 0th-order light reflecting layer 726. In the present embodiment, in the optical element 720, the first holographic optical element layer 724, the second holographic optical element layer 725, and the 0th-order light reflecting layer 726 may be laminated in this order from an outside world side. The 0th-order light reflecting layer 726 may reflect 0th-order light having passed through the first holographic optical element layer 724 and the second holographic optical element layer 725 to advance in a direction other than the eyeball. According to this configuration, since the video display light can be made to reach the eyeball 730 without being affected by the 0th-order light, a video image can be clearly recognized.

Note that, similarly to the holographic optical element layer 721 described above, the first holographic optical element layer 724 and/or the second holographic optical element layer 725 may be formed with, for example, multiple three holograms diffracting red, green, and blue light in one layer, or may include a plurality of layers. The plurality of layers may be configured to diffract light having a different wavelength from one another. By configuring the first holographic optical element layer 724 and/or the second holographic optical element layer 725 with the plurality of layers, diffraction efficiency of video display light can be improved.

### (7) Sixth Example of First Embodiment (Configuration Example of Video Projection Device)

According to one implementation aspect of the present technology, the projection optical system may include a light discrimination element. An example of the optical element in the present implementation aspect will be described with reference to FIGS. 28 to 32.

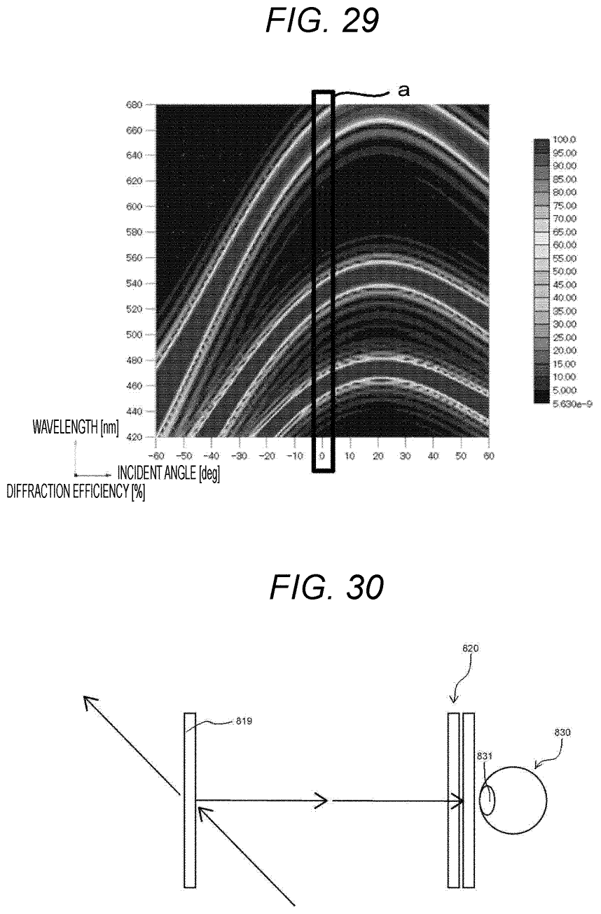

FIG. 28 shows characteristics of diffraction efficiency of a holographic optical element that is created such that, in a case where a lamp with a wide wavelength band is used as a light source and the optical element includes two optical element layers, light incident on the first layer on the eyeball side at 0 degrees with respect to an optical axis is reflected and diffracted in an original direction in a case where light of all wavelengths is incident on the optical element. FIG. 29 is a view showing a part of a diffracted light beam component of light reflected and diffracted in the original direction and to be collected near the pupil by the second layer on an outer side, and showing characteristics of diffraction efficiency of a holographic optical element that is created to reflect and diffract in, here, a direction of 45 degrees. Note that design wavelengths of the holograms included in the optical element are 460 nm, 532 nm, and 660 nm.

An area a in FIG. 28 shows a wavelength component of light incident on the first layer on the eyeball side of the optical element at 0 degrees with respect to the optical axis. An area a in FIG. 29 shows a wavelength component of light incident on the second layer on the outer side of the optical element at 0 degrees with respect to the optical axis. When the wavelength component in the area a is reflected and diffracted, the wavelength component is collected near the pupil. Therefore, a wavelength to be diffracted by the optical element is the wavelength component in the area a.

However, in a case where the light source has a wide wavelength band, such as a lamp, as shown in FIGS. 28 and 29, a wavelength component other than the area a is also diffracted in the first layer and the second layer of the optical element. When the wavelength component other than the area a is diffracted by the optical element, light other than desired light reaches the retina, so that a desired image cannot be obtained.

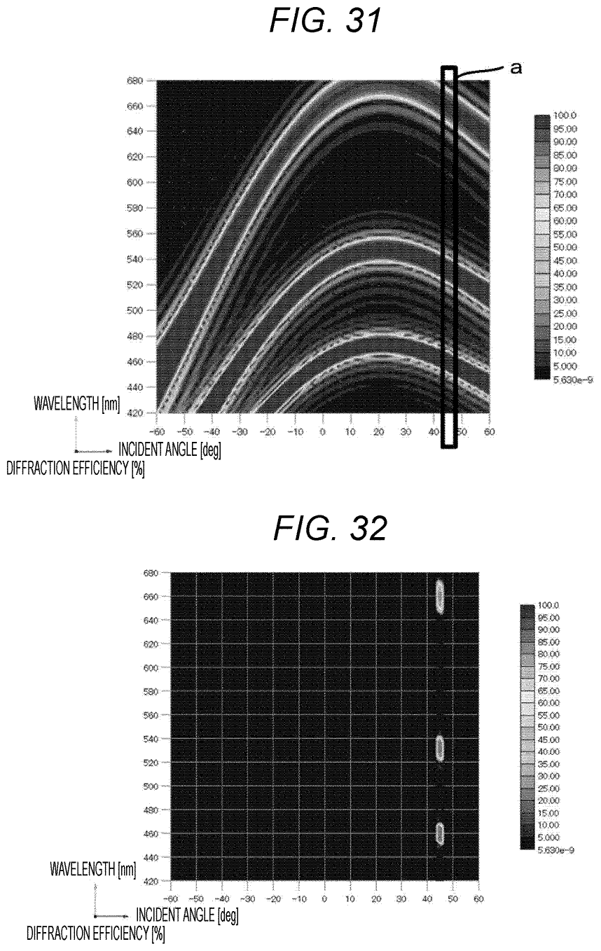

Therefore, as shown in FIG. 30, a light discrimination element 819 is provided. The light discrimination element 819 diffracts only a wavelength component to be diffracted by the optical element 820, and transmits other wavelength components. FIG. 31 is a view showing characteristics of diffraction efficiency of a holographic optical element that is created to reflect and diffract light incident from a direction of 45 degrees in the light discrimination element, in a front direction (0 degree direction) of the eyeball. That is, according to the light discrimination element 819, since only a wavelength of the area a in FIG. 31 is reflected and diffracted in the eyeball direction in video display light emitted from the light source, other unnecessary wavelength components can be separated and removed.

By separating only the desired wavelength component with the light discrimination element 819 as shown in FIG. 32, it becomes difficult for undesired light to reach the retina.

### 2. Second Embodiment (Video Projection Device)

The present technology also provides a video projection device included in a video projection system according to the present technology. The video projection device includes a projection optical system configured to project video display light onto an eyeball. The video projection device is used in combination with an optical element configured to cause the video display light to be collected near a pupil and then to reach a retina, and a positional relationship between the optical element and the eyeball is fixed in use of the combination.

The video projection device is the video projection device described in 1. Described above, and all of the details described for the video projection device also apply to the video projection device according to the present embodiment. Therefore, a description of the video projection device will be omitted.

By using the video projection device in combination with the optical element described in 1. described above, the effect as described above can be obtained.

### 3. Third Embodiment (Video Display Light Diffraction Optical Element)

The present technology also provides a video display light diffraction optical element included in a video projection system according to the present technology. The video display light diffraction optical element is used in combination with a video projection device equipped with a projection optical system configured to project video display light onto an eyeball. In use in the combination, a positional relationship with the eyeball is fixed, and the video display light is collected near a pupil and then reaches a retina.

The video display light diffraction optical element is the optical element described in 1. described above, and all of the details described for the optical element also apply to the video display light diffraction optical element in the present embodiment. Therefore, a description of the optical element is omitted.

By using the video display light diffraction optical element in combination with the video projection device described in 1. described above, the effect as described above can be obtained.

### Fourth Embodiment (Video Projection Method)

The present technology provides a video projection method including: a projection step of projecting video display light from a video projection device toward an eyeball; and a light collecting step of causing video display light projected in the projection step to be collected near a pupil with an optical element and then to reach a retina. In the video projection method, the projection step and the light collecting step are performed in a state where a positional relationship between the optical element and the eyeball is fixed.

In the projection step, the video projection device projects video display light toward the eyeball. The video projection device used in the projection step is the video projection device described in 1. described above. A main light beam of the video display light may be substantially parallel to an optical axis.

Next, in the light collecting step, the optical element causes the video display light projected in the projection step to be collected near the pupil and then to reach the retina. The optical element used in the light collecting step is the optical element described in 1. described above. The optical element may be used in a state of being in contact with a surface of the eyeball, or may be used without contacting the surface of the eyeball.

The video projection method according to the present technology produces the effect as described in 1. described above.

### 5. Modified Example (Video Projection System)

In a video projection system of a modified example according to the present technology, an optical element may have a holographic optical element layer, and the holographic optical element layer diffracts the video display light incident on the optical element to be collected on a front side or a back side from a pupil.

The video projection system of the modified example according to the present technology may further include: an eyeball position detection device configured to detect a position of an eyeball with respect to the optical element; and a control unit configured to specify a light beam group that reaches a retina on the basis of a detection result of the eyeball position detection device, and control a projection optical system to form the video display light with the light beam group.

According to the video projection system of this modified example, it is possible to reliably visually recognize video display light without having a mechanical mechanism such as an eye tracking mechanism, that is, while reducing a size of the entire system and power consumption.

Hereinafter, video projection systems of the modified examples (Modified Examples 1 and 2) according to the present technology will be specifically described.

### Video Projection System of Modified Example 1

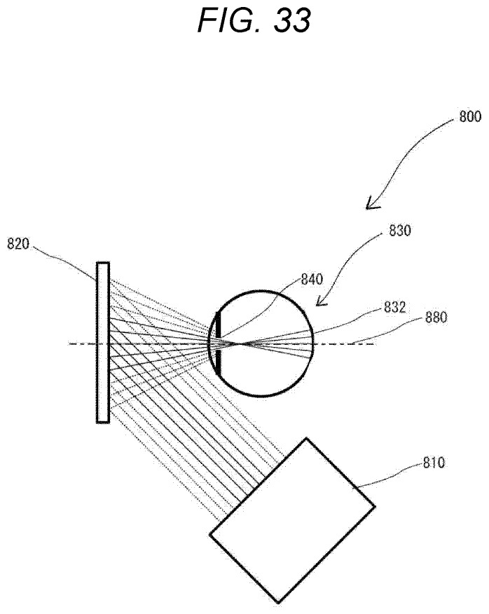

FIGS. 33 to 35 are views showing a video projection system 800 of Modified Example 1 according to the present technology.

As shown in FIG. 33, the video projection system 800 includes: a light source (not shown); a projection optical system 810 configured to project light from the light source; and an optical element 820 having a substantially flat plate shape and configured to diffract the light projected from the projection optical system 810, toward an eyeball 830.

The projection optical system 810 may include a two-dimensional array display element, or may include a scanning mirror.

The optical element 820 is not a contact-lens-shaped optical element, but is an optical element that is used without contacting an eyeball.

A holographic optical element layer of the optical element 820 may be a diffraction optical element of a volume phase type of a photopolymer, or may be a diffraction optical element of a surface relief type generally called DOE.

The optical element 820 diffracts light emitted from the light source (not shown) and projected from the projection optical system 810 to be collected on a back side (a retina 832 side) of a pupil 840.

That is, in the video projection system 800, a positional relationship between the optical element 820 and the eyeball 830 is set such that the light projected from the projection optical system 810 and diffracted by the optical element 820 is collected on a back side of the pupil 840 (the retina 832 side).

In the example of FIG. 33, the eyeball 830 faces the optical element 820. In detail, a center of the pupil 840 and a center of the eyeball 830 are located on a straight line 880 (indicated by a one dotted chain line in FIG. 33) passing through a center of the optical element 820 and being orthogonal to the optical element 820.

In this case, among all light beams projected from the projection optical system 810, light beams on a periphery (shown by dashed lines in FIG. 33) are blocked by a peripheral part of the pupil 840, while central light beams (shown by solid lines in FIG. 33) pass through the pupil 840 and reach the retina 832. That is, light beams in a certain range among the all light beams described above reach the retina 832.

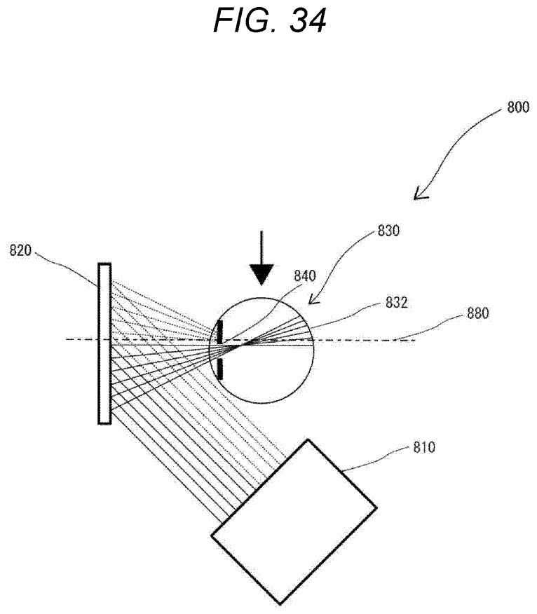

In the example of FIG. 34, the eyeball 830 is displaced in a direction orthogonal to the straight line 880 with respect to the straight line 880 (indicated by a one dotted chain line in FIG. 34), from a position facing the optical element 820 (a position shown in FIG. 33). In this case, among all light beams projected from the projection optical system 810, light beams on one side (shown by dashed lines in FIG. 34) are blocked by a peripheral part of the pupil 840, while light beams on another side (shown by solid lines in FIG. 34) pass through the pupil 840 and reach the retina 832. That is, light beams in a certain range among the all light beams described above reach the retina 832.

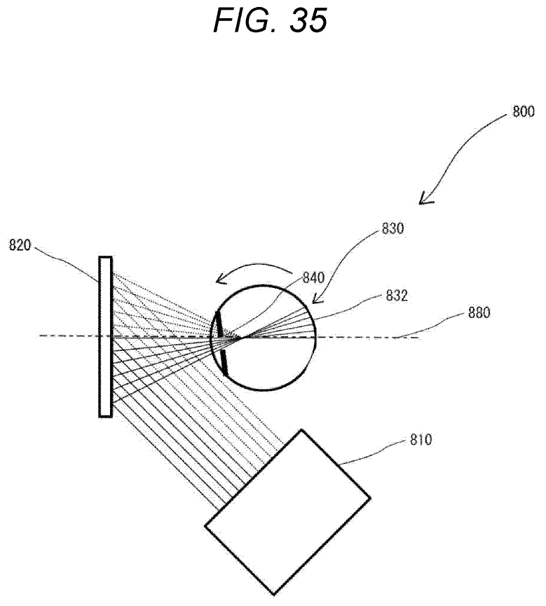

In the example of FIG. 35, the eyeball 830 is rotated from a position facing the optical element 820 (a position shown in FIG. 33) so as to form an angle with respect to the straight line 880. In this case, among all light beams projected from the projection optical system 810, light beams on one side (shown by dashed lines in FIG. 35) are blocked by a peripheral part of the pupil 840, while light beams on another side (shown by solid lines in FIG. 35) pass through the pupil 840 and reach the retina 832. That is, light beams in a certain range among the all light beams described above reach the retina 832.

### Video Projection System of Modified Example 2

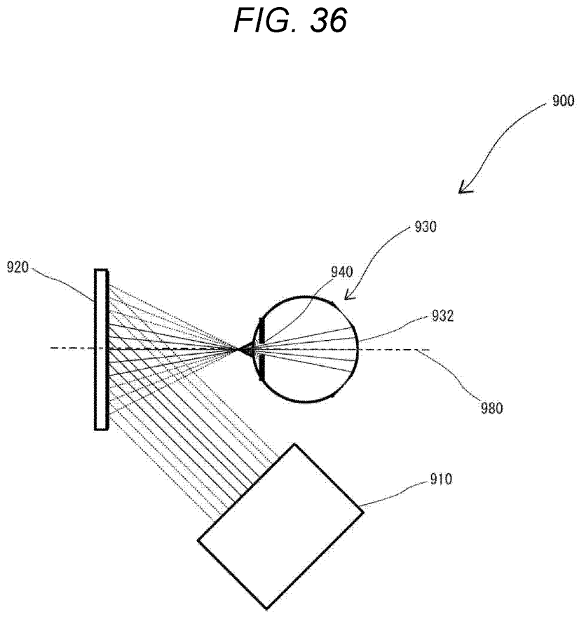

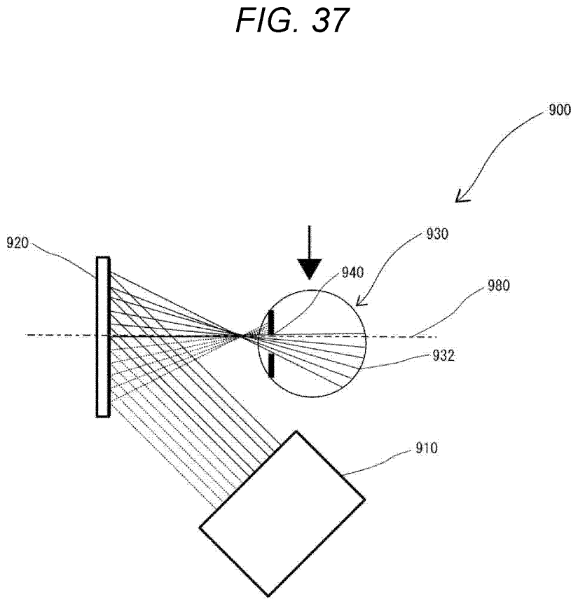

FIGS. 36 to 38 are views showing a video projection system 900 of Modified Example 2 according to the present technology.

As shown in FIG. 36, the video projection system 900 includes: a light source (not shown); a projection optical system 910 configured to project light from the light source; and an optical element 920 having a substantially flat plate shape and configured to diffract the light projected from the projection optical system 910, toward an eyeball 930.

The projection optical system 910 may include a two-dimensional array display element, or may include a scanning mirror.

The optical element 920 is not a contact-lens-shaped optical element, but is an optical element used without contacting the eyeball.

A holographic optical element layer of the optical element 920 may be a diffraction optical element of a volume phase type of a photopolymer, or may be a diffraction optical element of a surface relief type generally called DOE.

The optical element 920 diffracts light emitted from the light source (not shown) and projected from the projection optical system 910 to be collected on a front side of a pupil 940 (a cornea side, that is, a side opposite to a retina side).

That is, in the video projection system 900, a positional relationship between the optical element 920 and the eyeball 930 is set such that the light projected from the projection optical system 910 and diffracted by the optical element 920 is collected on the front side (the cornea side) of the pupil 940.

In the example of FIG. 36, the eyeball 930 faces the optical element 920. More specifically, a center of the pupil 940 and a center of the eyeball 930 are located on a straight line 980 (indicated by a one dotted chain line in FIG. 36) passing through a center of the optical element 920 and being orthogonal to the optical element 920.

In this case, among all light beams projected from the projection optical system 910, light beams on a periphery (shown by dashed lines in FIG. 36) are blocked by a peripheral part of the pupil 940, while central light beams (shown by solid lines in FIG. 36) pass through the pupil 940 and reach the retina 932. That is, light beams in a certain range among the all light beams described above reach the retina 932.

In the example of FIG. 37, the eyeball 930 is displaced in a direction orthogonal to the straight line 980 with respect to the straight line 980 (indicated by a one dotted chain line in FIG. 37), from a position facing the optical element 920 (a position shown in FIG. 36). In this case, among all light beams projected from the projection optical system 910, light beams on one side (shown by dashed lines in FIG. 37) are blocked by a peripheral part of the pupil 940, while light beams on another side (shown by solid lines in FIG. 37) pass through the pupil 940 and reach on the retina. That is, light beams in a certain range among the all light beams described above reach the retina 932.

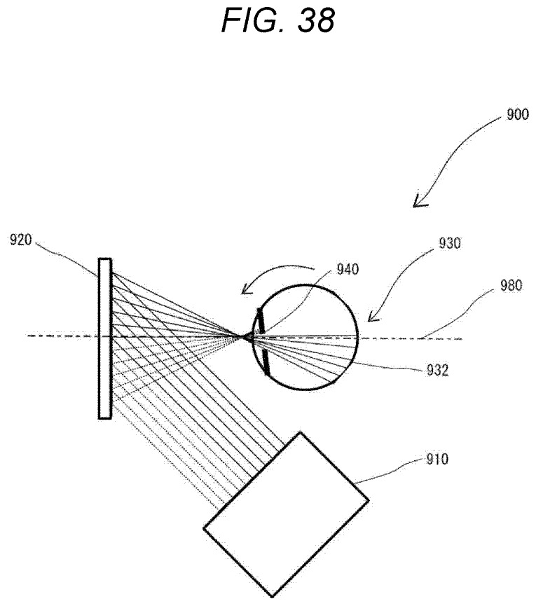

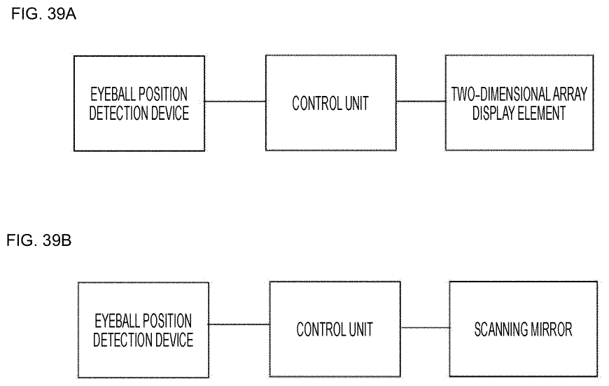

In the example of FIG. 38, the eyeball 930 is rotated from a position facing the optical element 920 (a position shown in FIG. 36) so as to form an angle with respect to the straight line 980. In this case, among all light beams projected from the projection optical system 910, light beams on one side (shown by dashed lines in FIG. 38) are blocked by a peripheral part of the pupil 940, while light beams on another side (shown by solid lines in FIG. 38) pass through the pupil 940 and reach on the retina. That is, light beams in a certain range among the all light beams described above reach the retina 932.

In the video projection systems 800 and 900 of the Modified Examples 1 and 2 described above, light diffracted by the optical element is collected on a back side or a front side of the pupil. Therefore, regardless of a positional relationship between the optical element and the eyeball, it is possible to reliably cause a certain range of light beams to reach the retina, among all light beams projected from the projection optical system.

On the other hand, in a case where the optical element diffracts light projected from the projection optical system to be collected on the pupil, most of all light beams diffracted by the optical element are collected on a peripheral part of the pupil and blocked depending on a position of the eyeball with respect to the optical element, which may cause a possibility that almost no light will reach the retina.

As shown in FIGS. 39(a) and 39(b), preferably, the video projection systems 800 and 900 further include: an eyeball position detection device (an eye sensing device) configured to detect a position of the eyeball with respect to an optical element; and a control unit configured to specify a light beam group that reaches a retina on the basis of a detection result of the eyeball position detection device, and control the projection optical system to form the video display light with the light beam group.

The eyeball position detection device detects a position of the eyeball with respect to the optical element by the method as described above. The eyeball position detection device may be provided integrally with the optical element.

The eyeball position detection device may detect, as a position of the eyeball with respect to the optical element, for example, a displacement of the eyeball from the straight line 880 shown in FIGS. 33 to 35 and the straight line 980 shown in FIGS. 36 to 38 (including a displacement in a direction orthogonal to the straight line 880 or the straight line 980 and a displacement in a rotational direction around that direction).

The control unit specifies a light beam group that reaches the retina in accordance with a detection result of the eyeball position detection device, that is, a position of the eyeball with respect to the optical element, and controls a two-dimensional array display element or a scanning mirror of the projection optical system to form the video display light with the light beam group (see FIGS. 39(a) and 39(b)). Note that, by specifying a light beam group that does not reach the retina among all light beams projected from the projection optical system, it is also possible to substantially specify a light beam group that reaches the retina.

Note that the present technology can have the following configurations.

[1]

A video projection system including: a video projection device equipped with a projection optical system configured to project video display light onto an eyeball; and

an optical element configured to cause the video display light to be collected near a pupil and then to reach a retina, in which

the video projection system is used in a state where a positional relationship between the optical element and the eyeball is fixed.

[2]

The video projection system according to [1], in which a main light beam of the video display light incident on the optical element is substantially parallel to an optical axis.

[3]

The video projection system according to [1] or [2], in which the optical element is used in contact with a surface of the eyeball.

[4]

The video projection system according to [3], in which the video projection system is used in a state where a positional relationship between the optical element and a pupil is fixed.

[5]

The video projection system according to [1] or [2], in which the optical element is used without contacting a surface of the eyeball.

[6]

The video projection system according to any one of [1] to [5], in which the optical element has a curved surface, and a curvature center of the curved surface and a curvature center of a curved surface of the surface of the eyeball are substantially concentric.

[7]

The video projection system according to any one of [1] to [6], in which the optical element is a holographic optical element.

[8]

The video projection system according to any one of [1] to [7], in which

the projection optical system includes a two-dimensional array display element, and

the two-dimensional array display element forms the video display light.

[9]

The video projection system according to any one of [1] to [7], in which

the projection optical system includes a scanning mirror, and

the scanning mirror forms the video display light.

[10]

The video projection system according to any one of [1] to [9], in which

the projection optical system includes a partial multiplexing member, and

the partial multiplexing member reflects or diffracts the video display light to reach the optical element.

[11]

The video projection system according to any one of [1] to [10], in which

the optical element has a holographic optical element layer, and

the holographic optical element layer diffracts the video display light incident on the optical element to be collected near a pupil.

[12]

The video projection system according to [11], in which

the optical element further has a 0th-order light reflecting layer,

the optical element has a lamination in an order of the holographic optical element layer and the 0th-order light reflecting layer from an outside world side, and

the 0th-order light reflecting layer reflects 0th-order light having passed through the holographic optical element layer to advance in a direction other than an eyeball.

[13]

The video projection system according to [11] or [12], in which

the holographic optical element layer includes a plurality of layers, and

the plurality of layers diffracts light having a different wavelength from one another.

[14]

The video projection system according to any one of [1] to [10], in which

the optical element has a first holographic optical element layer and a second optical element layer,

the optical element has a lamination in an order of the first holographic optical element layer and the second holographic optical element layer from an outside world side,

the first holographic optical element layer transmits the video display light,

the second holographic optical element layer reflects the transmitted video display light, and

the first holographic optical element layer diffracts the reflected video display light to be collected near a pupil.

[15]

The video projection system according to [14], in which

the optical element further has a 0th-order light reflecting layer,

the optical element has a lamination in an order of the first holographic optical element layer, the second holographic optical element layer, and the 0th-order light reflecting layer from an outside world side, and

the 0th-order light reflecting layer reflects 0th-order light having passed through the first and second holographic optical element layers to advance in a direction other than an eyeball.

[16]

The video projection system according to [14] or [15], in which

the first and/or second holographic optical element layer includes a plurality of layers, and

the plurality of layers diffracts light having a different wavelength from one another.

[17]

The video projection system according to any one of [1] to [16], in which

the projection optical system includes a light discrimination element, and

the light discrimination element separates and removes an unnecessary wavelength component from the video display light.

The video projection system according to [1] to [17], in which

the optical element has a holographic optical element layer, and

the holographic optical element layer diffracts the video display light incident on the optical element to be collected on a front side or a back side of a pupil.

The video projection system according to [18], further including:

an eyeball position detection device configured to detect a position of the eyeball with respect to the optical element; and

a control unit configured to specify a light beam group that reaches a retina on the basis of a detection result of the eyeball position detection device, and control the projection optical system to form the video display light with the light beam group.

A video projection device including:

a projection optical system configured to project video display light onto an eyeball, in which

the video projection device is used in combination with an optical element configured to cause the video display light to be collected near a pupil and then to reach a retina, and a positional relationship between the optical element and the eyeball is fixed in use of the combination.

A video display light diffraction optical element that is used in combination with a video projection device equipped with a projection optical system configured to project video display light onto an eyeball, in which

a positional relationship with the eyeball is fixed in use in the combination, and

the video display light is collected near a pupil and reaches a retina.

A video projection method including:

a projection step of projecting video display light from a video projection device toward an eyeball; and

a light collecting step of causing video display light projected in the projection step to be collected near a pupil with an optical element and then to reach a retina, in which

the projection step and the light collecting step are performed in a state where a positional relationship between the optical element and the eyeball is fixed.

### REFERENCE SIGNS LIST

100, 200 Video projection system
101, 201 Video projection device
110, 210 Projection optical system
111 Two-dimensional array display element
211 Light source
212 Scanning mirror
112, 113, 213 Lens
120, 220 Optical element
130, 230 Eyeball
131, 231 Crystalline lens
132, 232 Retina

1. A video projection system comprising:
a video projection device equipped with a projection optical system configured to project video display light onto an eyeball; and
an optical element configured to cause the video display light to be collected near a pupil and then to reach a retina, wherein
the video projection system is used in a state where a positional relationship between the optical element and the eyeball is fixed.

2. The video projection system according to claim 1, wherein a main light beam of the video display light incident on the optical element is substantially parallel to an optical axis.

3. The video projection system according to claim 1, wherein the optical element is used in contact with a surface of the eyeball.

4. The video projection system according to claim 3, wherein the video projection system is used in a state where a positional relationship between the optical element and a pupil is fixed.

5. The video projection system according to claim 1, wherein the optical element is used without contacting a surface of the eyeball.

6. The video projection system according to claim 1, wherein the optical element has a curved surface, and a curvature center of the curved surface and a curvature center of a curved surface of the surface of the eyeball are substantially concentric.

7. The video projection system according to claim 1, wherein the optical element is a holographic optical element.

8. The video projection system according to claim 1, wherein
the projection optical system includes a two-dimensional array display element, and
the two-dimensional array display element forms the video display light.

9. The video projection system according to claim 1, wherein
the projection optical system includes a scanning mirror, and
the scanning mirror forms the video display light.

10. The video projection system according to claim 1, wherein
the projection optical system includes a partial multiplexing member, and
the partial multiplexing member reflects or diffracts the video display light to reach the optical element.

11. The video projection system according to claim 1, wherein
the optical element has a holographic optical element layer, and
the holographic optical element layer diffracts the video display light incident on the optical element to be collected near a pupil.

12. The video projection system according to claim 11, wherein
the optical element further has a 0th-order light reflecting layer,
the optical element has a lamination in an order of the holographic optical element layer and the 0th-order light reflecting layer from an outside world side, and
the 0th-order light reflecting layer reflects 0th-order light having passed through the holographic optical element layer to advance in a direction other than an eyeball.

13. The video projection system according to claim 11, wherein
the holographic optical element layer includes a plurality of layers, and
the plurality of layers diffracts light having a different wavelength from one another.

14. The video projection system according to claim 1, wherein
the optical element has a first holographic optical element layer and a second holographic optical element layer,
the optical element has a lamination in an order of the first holographic optical element layer and the second holographic optical element layer from an outside world side,
the first holographic optical element layer transmits the video display light,
the second holographic optical element layer reflects the transmitted video display light, and
the first holographic optical element layer diffracts the reflected video display light to be collected near a pupil.

15. The video projection system according to claim 14, wherein
the optical element further has a 0th-order light reflecting layer,
the optical element has a lamination in an order of the first holographic optical element layer, the second holographic optical element layer, and the 0th-order light reflecting layer from an outside world side, and
the 0th-order light reflecting layer reflects 0th-order light having passed through the first and second holographic optical element layers to advance in a direction other than an eyeball.

16. The video projection system according to claim 14, wherein
the first and/or second holographic optical element layer includes a plurality of layers, and
the plurality of layers diffracts light having a different wavelength from one another.

17. The video projection system according to claim 1, wherein
the projection optical system includes a light discrimination element, and
the light discrimination element separates and removes an unnecessary wavelength component from the video display light.

18. The video projection system according to claim 1, wherein
the optical element has a holographic optical element layer, and
the holographic optical element layer diffracts the video display light incident on the optical element to be collected on a front side or a back side of a pupil.

19. The video projection system according to claim 18, further comprising:
an eyeball position detection device configured to detect a position of the eyeball with respect to the optical element; and
a control unit configured to specify a light beam group that reaches a retina on a basis of a detection result of the eyeball position detection device, the control unit being configured to control the projection optical system to form the video display light with the light beam group.

20. A video projection device comprising:
a projection optical system configured to project video display light onto an eyeball, wherein
the video projection device is used in combination with an optical element configured to cause the video display light to be collected near a pupil and then to reach a retina, and a positional relationship between the optical element and the eyeball is fixed in use of the combination.

21. A video display light diffraction optical element that is used in combination with a video projection device equipped with a projection optical system configured to project video display light onto an eyeball, wherein
a positional relationship with the eyeball is fixed in use in the combination, and
the video display light is collected near a pupil and reaches a retina.

22. A video projection method comprising:
a projection step of projecting video display light from a video projection device toward an eyeball; and
a light collecting step of causing video display light projected in the projection step to be collected near a pupil with an optical element and then to reach a retina, wherein
the projection step and the light collecting step are performed in a state where a positional relationship between the optical element and the eyeball is fixed.
